(19) United States
(12) Patent Application Publication
(10) Pub. No.: US 2002/0043633 A1
(43) Pub. Date: Apr. 18, 2002

(54) Method and apparatus for collimating light for detection

(75) Inventors: Warren Bruce Jackson, San Francisco, CA (US); David Kalman Biegelsen, Portola Valley, CA (US); Lars Erik Swartz, Sunnyvale, CA (US)

Correspondence Address: Patent Documentation Center, Xerox Corporation, 20th Floor, 100 Clinton Ave. S., Xerox Square, Rochester, NY, 14644, US

(73) Assignee: Xerox Corporation

(21) Appl. No.: 10/022,718

(22) Filed: Dec. 20, 2001

Related U.S. Application Data
(62) Division of application No. 09/448,803, filed on Nov. 24, 1999.

(51) Int. Cl. G01V 8/00; G01N 21/86

(52) U.S. Cl. 250/559.36

(57) ABSTRACT

This invention relates to a method and apparatus for collecting or collimating light for detection. More particularly, the invention is directed to a technique for detecting the edge of an object using an apparatus having a plurality barriers or shield structures that are advantageously aligned with an optical sensor array to collect or spatially filter generated light for improved detection of the light. The invention also relates to methods of forming the structure. Application of the invention is found in the field of detecting edges of objects such as sheets of paper that are fed through imaging devices along a paper path.

### BACKGROUND OF THE INVENTION

This invention relates to a method and apparatus for collimating or collecting light for detection. More particularly, the invention is directed to a technique for detecting the edge of an object using an apparatus having a plurality of barriers or shield structures that are advantageously aligned with an optical sensor array to collect or spatially filter generated light for improved detection of the light. The invention also relates to methods of forming the structure. Application of the invention is found in the field of detecting edges of objects such as sheets of paper that are fed through imaging devices along a paper path.

While the invention is particularly directed to the art of collecting or collimating light in the context of detecting edges of objects (for example, sheets of paper) using optical sensors, and will be thus described with specific reference thereto, it will be appreciated that the invention may have usefulness in other fields and applications. For example, the invention may be used in any application where waves, such as light waves and sound waves, are generated and detected for a particular purpose.

By way of background, there is a need for collimated optical systems that provide a large depth of focus with high spatial resolution over large areas. In this regard, there is a need for inexpensive, efficiently implemented optical detection systems that are useful for detecting the edges and/or position of paper in imaging applications.

In the past, laser arrays have been proposed for this purpose. However, arrays of lasers are relatively expensive, and therefore undesirable, to implement.

Various optical sensing arrays are known in the imaging field. For example, U.S. Pat. No. 5,121,254 describes an image transmitting element and process for producing a photo-shield spacer plate used therein. This patent, however, does not describe any use of the device to detect edges or the position of paper in imaging applications. Moreover, because lenses are used in such devices, the costs are undesirably increased. Further, the process disclosed to form these devices presents a variety of difficulties, including alignment difficulties, if used to form edge detecting devices as contemplated by the present invention.

Optical systems utilizing louvers are also known. However, such systems are generally only adaptable to be one dimensional and are difficult to align with known high resolution sensor arrays.

The present invention contemplates a new method and apparatus for collecting or collimating light for detection that resolves the above-referenced difficulties and others.

### SUMMARY OF THE INVENTION

A method and apparatus for collecting or collimating light for detection are provided. Specifically, a technique is provided for detecting the edge of an object using an apparatus having a plurality of barriers or shield structures that are advantageously aligned with an optical sensor array to collect or spatially filter generated light for improved detection of the light.

In one aspect of the invention, the method comprises steps of transporting the object to a position between the light source and a first group of a plurality of discrete optical sensors positioned on a substrate—the first group being positioned relative to the object such that the light is substantially blocked from being detected by the first group, detecting first portions of the light by a second group of the plurality of discrete optical sensors, absorbing second portions of the light by a plurality of light absorbing barrier structures extending between the plurality of discrete optical sensors and the light source—each of the plurality of barrier structures defining a channel aligned with at least one of the plurality of sensors, and determining the location of the edge based on the detection of the light by the second group of the plurality of optical sensors. The first portions of light are directly nearly parallel to an axis of the channel and the second portions of light are directed at angles generally non-parallel to the axis.

In another aspect of the invention, an apparatus for use in a system having light generated therein by a light source comprises a substrate, at least one optical sensor positioned on the substrate to detect first portions of the light, and at least one light absorbing barrier structure extending between the plurality of discrete optical sensors and the light source—the each barrier structure defining a channel aligned with the at least one sensor and being positioned to absorb second portions of the light, wherein the optical sensor detects the first portions of the light and the at least one barrier structure absorbs the second portions of the light based on a position of the edge of the object in the path.

In another aspect of the invention, the at least one optical sensor is a plurality of optical sensors and each of the plurality is aligned with a barrier structure.

In another aspect of the invention, the channel is substantially circular in cross section.

In another aspect of the invention, the channel is substantially polygonal in cross section.

In another aspect of the invention, the channel has a width and a length, an aspect ratio being defined based on the length divided by the width.

In another aspect of the invention, the aspect ratio is greater than 10:1.

In another aspect of the invention, the plurality of barrier structures is formed of light absorbing material.

In another aspect of the invention, the plurality of barrier structures is coated with light absorbing material.

In another aspect of the invention, the plurality of barrier structures extend from the plurality of sensors toward the path.

In another aspect of the invention, the plurality of barrier structures extend from the light source to the path.

In another aspect of the invention, a method of forming an optical sensor array device comprises steps of forming at least one optical sensor on a substrate, forming a thick film layer of light absorbing material over the substrate—the thick film layer having a thickness, forming a pattern on the thick film layer, and developing the thick film layer based on the pattern to form at least one aperture in the thick film—the at least one aperture exposing and being aligned with the at least one sensor and having a width wherein the thickness divided by the width defines an aspect ratio.

In another aspect of the invention, the substrate is formed of one of glass, silicon and plastic.

In another aspect of the invention, the substrate and the at least one sensor comprise a charge coupled device (CCD) array.

In another aspect of the invention, the aspect ratio is approximately 20:1.

In another aspect of the invention, a method of forming an optical sensor array device comprises steps of forming at least one optical sensor on a substrate, forming a thick film layer over the substrate—the thick film layer having a thickness, forming a pattern on the thick film layer, developing the thick film layer based on the pattern to form at least one aperture in the thick film—the at least one aperture exposing and being aligned with the at least one sensor and having a width, and coating the thick film layer with a light absorbing material wherein the thickness divided by the width defines an aspect ratio.

In another aspect of the invention, the aspect ratio is approximately 20:1.

In another aspect of the invention, the substrate is formed of one of glass, silicon and plastic.

In another aspect of the invention, the substrate and the at least one sensor comprise a charge coupled device (CCD) array.

In another aspect of the invention, the apparatus is flexible.

In another aspect of the invention, the apparatus comprises a multi-dimensional array of optical sensors and corresponding barrier structures.

In another aspect of the invention, the channels are filled with a transparent material.

In another aspect of the invention, the apparatus is coated with a transparent layer.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a perspective view of a sensor array device according to the present invention;

FIG. 2 is a top view of the sensor array device shown in FIG. 1;

FIG. 3 is a cross-sectional view along line 3-3 in FIG. 1;

FIG. 4 is a perspective view of an alternative embodiment of the present invention;

FIG. 5 is a method according to the present invention; and,

FIGS. 6(a)-6(f) illustrate methods of forming a sensor array device according to the present invention.

### DETAILED DESCRIPTION OF THE PREFERRED EMBODIMENTS

Referring now to the drawings wherein the showings are for purposes of illustrating the preferred embodiments of the invention only and not for purposes of limiting same, FIG. 1 provides a view of an overall preferred device according to the present invention. As shown, the sensor array device 10 includes a barrier structure or shield portion 12 having channels or apertures 14 disposed therein. The device 10 also includes a sensor array portion 16.

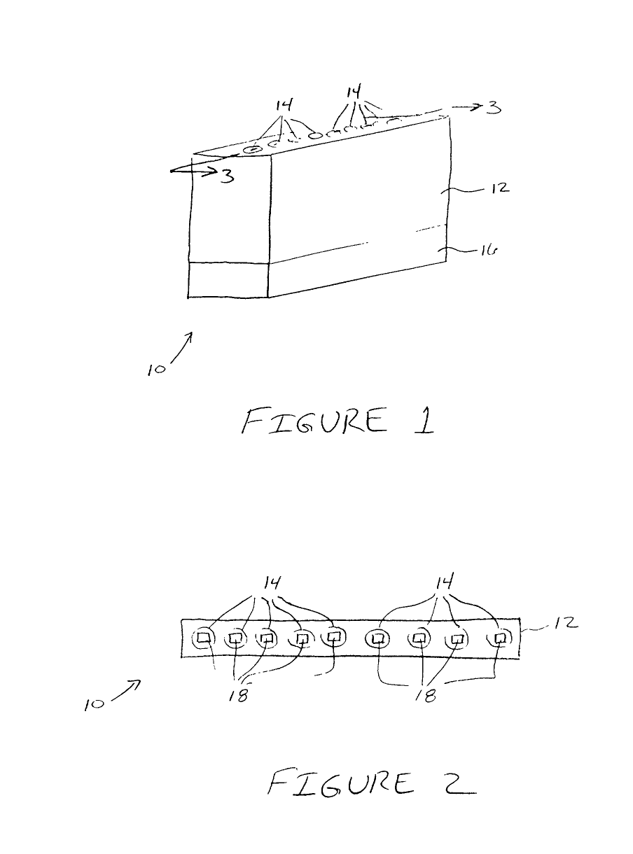

Referring now to FIG. 2, it can be seen that the apertures or channels 14 extend through the shield portion 12 to the sensor array portion 16 to expose sensor elements 18. It is to be appreciated that the sensor elements 18 are aligned with the apertures in a precise manner. This is accomplished during the formation process, as will be described in more detail below.

As shown, the channels 14 are generally circular in cross section (primarily due to the fabrication techniques) and the sensor elements are generally rectangular. However, it is to be appreciated that the channels 14 and sensor elements 18 may take a variety of shapes and forms, as will be apparent to those skilled in the art, so long as proper alignment is achieved. For example, the channels 14 may alternatively take on a shape of an ellipse or a rectangle, square, hexagon, or any other polygon.

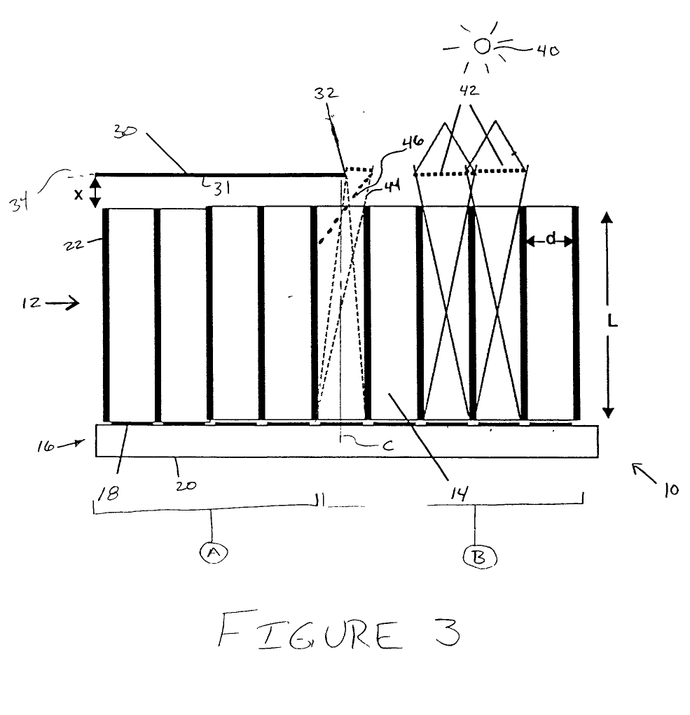

As shown in FIG. 3, a sensor array portion 16 has sensor elements, one of which is shown at 18, positioned on a substrate 20. Extending from the substrate 20 are barrier structures 22 which define the channels, one of which is shown at 14. The channels each have a centerline or longitudinal axis C.

An object 30 having an edge 32 is transportable along a path 34 to be positioned a distant x from the top of the device 10. It is to be appreciated that the object 30 may be a sheet of paper and the path 34 may be a paper path disposed within an imaging device such as a printer, copier, etc. The object 30 may also comprise other types of material (e.g. sheet metal, plastic, etc.) that take the form of a sheet or web.

A light source 40 is also shown in FIG. 3. The light source 40 may take a variety of forms well known to those skilled in the art and, typically, will produce overlapping fields of light 42.

As shown, the sensor array device 10 is able to detect the edge 32 of the object 30. In this regard, when the light source is positioned as in FIG. 3, light rays generated thereby are blocked by the object 30 such that a first group of sensors A do not detect any of the light. Conversely, a second group of detectors B detect first light portions (or rays) 44 that are not blocked by the object 30. In addition, second light portions 46 that are not blocked by the object 30 are absorbed into the barrier structures 22. This configuration allows for more accurate detection of the edge 32 because the barrier structures 22 absorb the stray light while such structures 22 allow light rays running generally parallel to the structures to be detected by the detecting elements 18. As a result, the shadow of the object remains generally aligned with its actual position and is not broadened to improve the precision of detection of the edge.

With further reference to FIG. 3, each channel 14 includes a width d and a height or thickness L. Of course, it is to be appreciated that the cross-section of the channels 14 may vary. For example, as noted above, the channels may be substantially circular, elliptical, or polygonal in cross-section. However, for simplicity, the various dimensional relationships will be explained in connection with a generally square cross-sectional tube. It is to be appreciated that the view shown in FIG. 3 that was noted as having circular cross-sectional channels (which in cross section also resembles a square cross section) will be used to explain the dimensional relationships for convenience.

More particularly, the variation of sensitivity with paper height x depends on the form of illumination used, e.g. reflected from the paper or top side incident light eclipsed by the sheet. For the latter case with square cross-section channels, the response of the sensor is that of the unblocked sensor for an edge position d/2 (1+2x/L) to the left of the channel centerline or axis C and linearly decreases to the response of a blocked sensor when the edge 32 moves to a position d/2 (1+2x/L) to the right of the channel in FIG. 3. The quantity d is the width of the channel and L is the length of the channel. The response of the detector as a function of edge position therefore extends over a region d(1+2x/L).

Another relational characteristic of the device according to the present invention is the aspect ratio. For purposes of the invention, the aspect ratio is defined as the height or thickness L of the barrier structures divided by the width d. Preferably, this ratio A=L/d is such that broadening is less than the channel width for the desired object stance x. In other words, d≧2x/A defines a desirable aspect ratio. For d=100 μm and x=1 mm, the aspect ratio A should be greater than 20. In many circumstances, an aspect ratio of greater than 10:1 will suffice.

It is to be recognized that the configuration shown in FIG. 3 may vary depending on the particular application. For example, the barrier structures 22 may be positioned to alternatively collect and/or collimate the light directly from the light source, as opposed to providing barriers in contact with the sensor array portion 16. For edge detection in this case, the object edge 30 is placed between the sensor array 18 and the barrier structures 22. Modifications to the system to implement such an alternative will be readily apparent to those skilled in the art. However, as an example, it is contemplated that the barrier structures could be positioned between the light source and the object 30 (or its path) such that the light source has portions aligned with the channels 14, which are in turn remotely aligned with each sensor 18. A light source comprised of LEDs would accommodate this configuration.

Another variation of the system is to replace the discrete detectors 18 with continuous detectors such as position sensitive detectors. Such continuous detectors are well known to those skilled in the art. Charge coupled devices (CCD's) are also contemplated for use with the present invention.

A still further alternative to the configuration shown in FIG. 3 is to position the light source such that light is reflected from the bottom 31 of the object 30 and detected by the optical elements 18, for example. In this case, of course, optical sensor elements and corresponding barrier structures that lie between the light source and the object would be detecting and/or absorbing light (i.e. reflected light) as opposed to the other sensor elements (and structures) as contemplated by FIG. 3.

As thus far described, the sensor array device 10 is a one dimensional array that is particularly useful for detecting the edge of objects such as paper in an imaging device. However, a number of sensor array devices may be arranged or positioned together to form a two dimensional array which, as those skilled in the art will appreciate, could usefully detect the position of paper or other objects. In this regard, with reference to FIG. 4, a two dimensional array device 100 is shown. This device includes sensor array devices 10′, 10″, and 10′″. It is to be appreciated that these sensor array devices are substantially identical to the sensor array device described in connection with FIGS. 1-3. Of course, modifications to any system incorporating the device 100 to determine position will be apparent to those skilled in the art.

In addition, in another alternative embodiment, the sensor array device is formed of materials that are flexible. The flexible materials selected may vary in composition and may be selected from a variety of such materials that are well known in the art such as dielectric coated stainless steel, polyimide and thin glass, the former two being preferred. As such, the devices are positioned and flexed, or curved, to conform to object paths that are curved.

In still further alternative embodiments, the array may be coated or provided with a thin layer of transparent material (such as polyethylene, polyester, or glass that is thermally or adhesively bonded) and/or the channels may be filled with a transparent material for purposes of protection and durability. The specific transparent fill material used may be selected from a variety that are well known and used in the field of optics including transparent polymer materials or ultraviolet curing epoxy material. Of course, preferably, these alternatives will not interfere with achieving the objectives of the invention.

Referring now to FIG. 5, a method 500 according to the present invention is described. Initially, the object (e.g. paper) is transported along a path to a position between a light source and a first group of a plurality of discrete optical sensors positioned on a substrate, preferably with barrier structures (step 502). It should be appreciated that the first group is positioned relative to the object such that the light is substantially blocked from being detected by the first group. This is illustrated in FIG. 3. First portions of the light are then detected by a second group of the plurality of discrete optical sensors (step 504). The first portions of light are generally directed in nearly parallel fashion to the axes of the channels. Again, this is illustrated in the configuration of FIG. 3.

Second portions of the light are absorbed by a plurality of light absorbing barrier structures extending between the plurality of discrete optical sensors and the light source (step 506). The second portions of light are generally directed at angles that are substantially non-parallel to the axes of the channels. The location of the edge of the object is then determined based on the detection of the light by examining the light intensity falling on both groups of sensors (step 508).

It is to be appreciated that the state of the sensors is detected by hardware and software that are well known to those skilled in the art. Likewise, the determination of the precise location of the edge relative to the system is well known and may be accomplished using various hardware and software techniques. Thresholding or curve fitting are two such examples.

Of course, this method according to the invention will be modified in the event that the configuration of the system shown, for example, in FIG. 3, is modified. For example, if light source 40 is positioned to reflect light from the bottom of the paper to the sensors, the paper is transported to a position in the path such that the light may be sufficiently reflected as opposed to being transported to a position between the light source and a plurality of sensors.

Whether a sensor array device 10 or a multi-dimensional device, such as the two dimensional sensor array device 100, is formed, it can be conveniently batch fabricated. In this regard, the batch fabrication may be accomplished via thick film photolithography using, for example, SU-8 or anodized aluminum electro-etching or using other known means to create high aspect ratio, thin, vertical wall structures in closed packed arrays of channel. Indeed, photolithographic means of formation is preferred according to this invention because of its inherent ability to align the sensor elements with the channels. Prior art configurations of shields or the like do not provide formation techniques that accomplish the alignment objectives of the present processes.

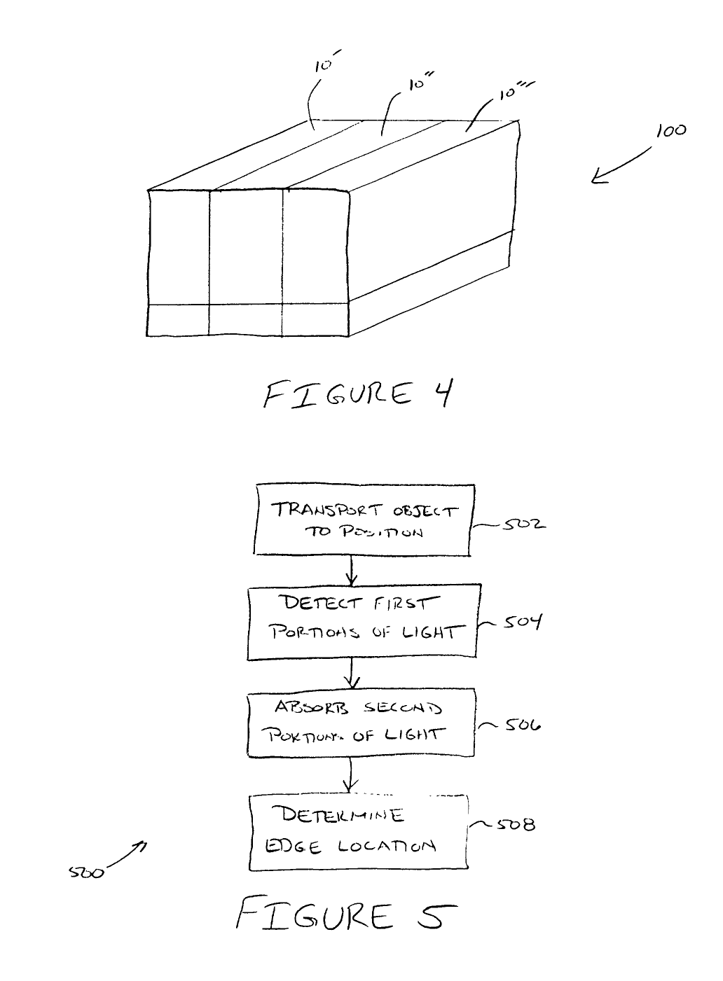

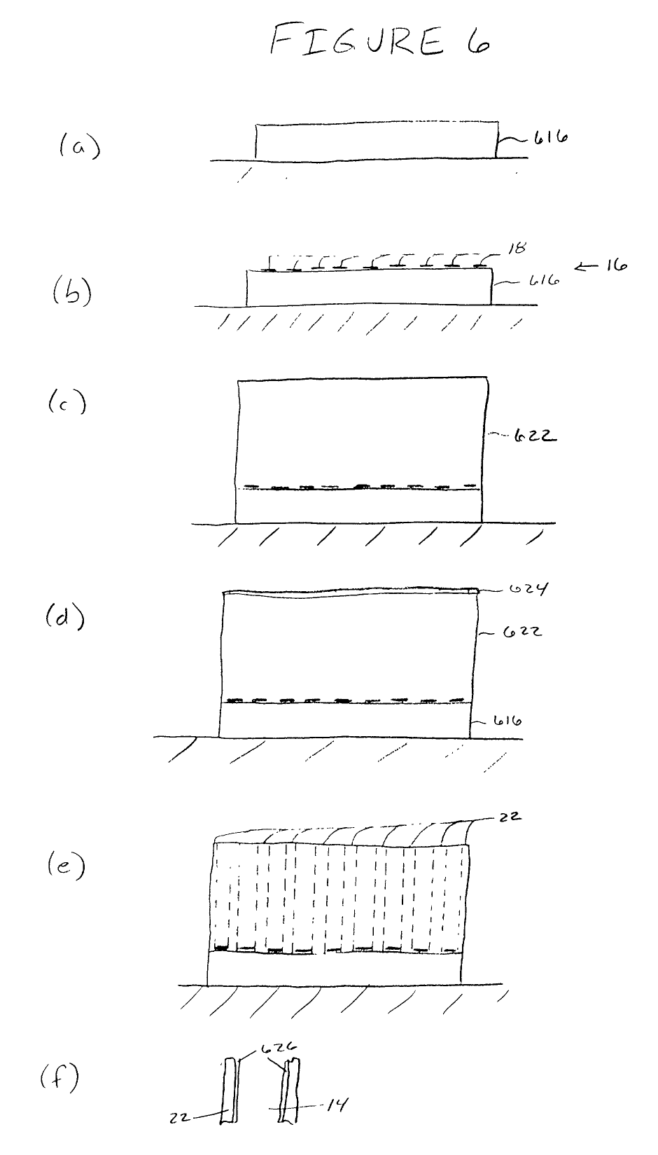

More particularly, with reference to FIGS. 6(a)-(f), the formation process begins with the provision of a substrate 16 (FIG. 6(a)). Optical sensors 18 are then formed on the substrate 16 (FIG. 6(b)). It is to be appreciated that the substrate may be glass (preferably), plastic, dielectric-coated metal, or silicon. It is to be further appreciated that the sensor may take the form of any variety of optical sensors that are well known in the art and can be formed on the substrate in a variety of manners.

A thick film layer of material 622 is then formed over the substrate to a thickness L (FIG. 6(c)). The thick film layer is preferably formed by spin coating but lamination or molding will suffice. The thick film layer may also be of a material that is light absorbing such as the preferred SU-8 or anodized aluminum or, as will be described later, a light absorbing coat could be applied to the barrier structures when completed.

A pattern 624 is then formed on the thick film layer by, for example, illumination with ultraviolet light through a mask (FIG. 6(d)). Holes are then created in the thick film to define the apertures 14 and the barrier structures 22 (FIG. 6(e)). Creation or development of the holes can be accomplished, for example, by etching or dissolution, as those skilled in the art will appreciate.

If the thick film layer is formed of a material that is light absorbing, then the formation process is complete. However, if the material is not light absorbing, a coat 626 of light absorbing material is applied to at least the inner surfaces of the channels 14 (FIG. 6(f)). Suitable light absorbing materials are well known to those versed in the art.

The process described in FIGS. 6(a)-6(f) is the preferred formation process for the devices according to the present invention. However, it is to be appreciated that other processes can be used to form the structures so long as the objectives of the present invention are achieved. For example, additional steps could be implemented to coat or provide the array with a thin transparent layer or fill the channels with a transparent material for purposes of protection and durability. Such steps may include the trimming of excess fill material using, for example, a doctor blade. In addition, processes could be implemented to form an apparatus that is flexible for flexing and positioning in a curved, 3-dimensional path.

The above description merely provides a disclosure of particular embodiments of the invention and is not intended for the purposes of limiting the same thereto. As such, the invention is not limited to only the above described embodiments. Rather, it is recognized that one skilled in the art could conceive alternative embodiments that fall within the scope of the invention.

Having thus described the invention we hereby claim:

1. A method for detecting a location of an edge of an object being transported along a path in a system having light generated therein by a light source, the method comprising steps of:
transporting the object to a position between the light source and a first group of a plurality of discrete optical sensors positioned on a substrate, the first group being positioned relative to the object such that the light is substantially blocked from being detected by the first group;
detecting first portions of the light by a second group of the plurality of discrete optical sensors;
absorbing second portions of the light by a plurality of light absorbing barrier structures extending between the plurality of discrete optical sensors and the light source, each of the plurality of barrier structures defining a channel aligned with at least one of the plurality of sensors, the first portions of light being directed nearly parallel to an axis of the channel and the second portions of light being directed at angles non-parallel to the axis of the channel; and,
determining the location of the edge based on the detection of the light by the second group of the plurality of optical sensors.

2. An apparatus for use in a system having light generated therein by a light source, the system having an object with an edge transported therethrough along a path, the apparatus comprising:
a substrate;
at least one optical sensor positioned on the substrate to detect first portions of the light; and,
at least one light absorbing barrier structure extending between the plurality of discrete optical sensors and the light source, the each barrier structure defining a channel aligned with the at least one sensor and being positioned to absorb second portions of the light,
wherein the optical sensor detects the first portions of the light and the at least one barrier structure absorbs the second portions of the light based on a position of the edge of the object in the path.

3. The apparatus as set forth in claim 2 wherein the at least one optical sensor is a plurality of optical sensors and each of the plurality is aligned with a barrier structure.

4. The apparatus as set forth in claim 2 wherein the channel is substantially circular in cross section.

5. The apparatus as set forth in claim 2 wherein the channel is substantially polygonal in cross section.

6. The apparatus as set forth in claim 2 wherein the channel has a width and a length, an aspect ratio being defined based on the length divided by the width.

7. The apparatus as set forth in claim 6 wherein the aspect ratio is greater than 10:1.

8. The apparatus as set forth in claim 2 wherein the plurality of barrier structures is formed of light absorbing material.

9. The apparatus as set forth in claim 2 wherein the plurality of barrier structures is coated with light absorbing material.

10. The apparatus as set forth in claim 2 wherein the plurality of barrier structures extend from the plurality of sensors toward the path.

11. The apparatus as set forth in claim 2 wherein the plurality of barrier structures extend from the light source to the path.

12. A method of forming an optical sensor array device, the method comprising steps of:
forming at least one optical sensor on a substrate;
forming a thick film layer of light absorbing material over the substrate, the thick film layer having a thickness;
forming a pattern on the thick film layer; and,
developing the thick film layer based on the pattern to form at least one aperture in the thick film, the at least one aperture exposing and being aligned with the at least one sensor and having a width,
wherein the thickness divided by the width defines an aspect ratio.

13. The method as set forth in claim 12 wherein the substrate is formed of one of glass, silicon and plastic.

14. The method is set forth in claim 12 wherein the substrate and the at least one sensor comprise a charge coupled device (CCD) array.

15. The method as set forth in claim 12 wherein the aspect ratio is approximately 20:1.

16. A method of forming an optical sensor array device, the method comprising steps of:
forming at least one optical sensor on a substrate;
forming a thick film layer over the substrate, the thick film layer having a thickness;
forming a pattern on the thick film layer;
developing the thick film layer based on the pattern to form at least one aperture in the thick film, the at least one aperture exposing and being aligned with the at least one sensor and having a width; and,
coating the thick film layer with a light absorbing material,
wherein the thickness divided by the width defines an aspect ratio.

17. The method as set forth in claim 16 wherein the aspect ratio is approximately 20:1.

18. The method as set forth in claim 16 wherein the substrate is formed of one of glass, silicon and plastic.

19. The method as set forth in claim 16 wherein the substrate and the at least one sensor comprise a charge coupled device (CCD) array.

20. The apparatus as set forth in claim 2 wherein the apparatus is flexible.

21. The apparatus as set forth in claim 2 wherein the apparatus comprises a multi-dimensional array of optical sensors and corresponding barrier structures.

22. The apparatus as set forth in claim 2 wherein the channels are filled with a transparent material.

23. The apparatus as set forth in claim 2 wherein the apparatus is coated with a transparent layer.
